(19) United States
(12) Patent Application Publication
(10) Pub. No.: US 2013/0257204 A1
(43) Pub. Date: Oct. 3, 2013

(54) MOTOR

(71) Applicant: NIDEC SANKYO CORPORATION, Nagano (JP)

(72) Inventors: Masato GOMYO, Nagano (JP); Ikuo AGEMATSU, Nagano (JP); Katsuhide YAJIMA, Nagano (JP)

(73) Assignee: NIDEC SANKYO CORPORATION, Nagano (JP)

(21) Appl. No.: 13/852,287

(22) Filed: Mar. 28, 2013

(30) Foreign Application Priority Data
Mar. 30, 2012 (JP) 2012-79971

(51) Int. Cl. H02K 7/08

(52) U.S. Cl. CPC H02K 7/08
USPC 310/90

(57) ABSTRACT

A motor may include a rotor having a rotation shaft, a stator formed in a tube shape and disposed around the rotor, a bearing member rotatably supporting the rotor, and an end plate with a spring part urging the rotation shaft in the motor axial line direction and holding the bearing member between the stator and the end plate. The bearing member may include a plate-shaped part whose outer shape dimension is smaller than an inner shape dimension of the stator and at least a part of the plate-shaped part is located on an inner side of the stator and an engagement part protruded from the plate-shaped part to an outer side in a radial direction and is overlapped with an end face of the stator. The end plate may be overlapped with the plate-shaped part on an opposite side to the stator.

### CROSS REFERENCE TO RELATED APPLICATION

The present invention claims priority under 35 U.S.C. §119 to Japanese Application No. 2012-079971 filed Mar. 30, 2012, the entire content of which is incorporated herein by reference.

### FIELD OF THE INVENTION

At least an embodiment of the present invention may relate to a motor.

### BACKGROUND

A motor commonly includes a rotation shaft which is extended from a rotor provided with a permanent magnet and a tube-shaped stator which is disposed around the rotor. A stepping motor has been proposed as the above-mentioned motor in which a bearing member rotatably supporting the rotation shaft is sandwiched between the stator and an end plate and the rotation shaft is urged in a motor axial line direction by a spring part provided in the end plate. In the stepping motor, a bearing member is provided with a first protruded part which is protruded toward a recessed part provided between the pole teeth of a stator core and a second protruded part engaged with an end face of the stator. The first protruded part is engaged with an end plate and the bearing member is held between the stator and the end plate (see Japanese Patent No. 4058324).

However, in a case of a structure that the first protruded part of the bearing member protruded into the recessed part of the stator core is supported by the end plate, an angular position of the bearing member and the end plate having the spring part is unable to be changed. Therefore, the angular position of the bearing member and the end plate cannot be adjusted to the optimum state according to conditions where the motor is used. For example, when a rotation shaft is rotated in a state that a load is applied to the rotation shaft from a side, an abnormal noise may occur at a contacted portion of the bearing member with the rotation shaft depending on an angular position of the bearing member and the end plate having the spring part. In this case, occurrence of the abnormal noise may be prevented by changing the angular position of the bearing member and the end plate in accordance with conditions where the motor is used, for example, in accordance with a direction of a load applied to the rotation shaft. However, in a case of the structure that the first protruded part of the bearing member is fitted into the recessed part of the stator core, the angular position cannot be changed.

### SUMMARY

In view of the problem described above, at least an embodiment of the present invention may advantageously provide a motor in which the bearing member and the end plate are capable of being disposed at an appropriate angular position.

According to at least an embodiment of the present invention, there may be provided a motor including a rotor having a rotation shaft, a stator which is formed in a tube shape and is disposed around the rotor, a bearing member which rotatably supports the rotor at one end part in a motor axial line direction of the stator, and an end plate which is provided with a spring part urging the rotation shaft in the motor axial line direction and holds the bearing member between the stator and the end plate. The bearing member includes a plate-shaped part whose outer shape dimension is smaller than an inner shape dimension of the stator, at least a part in a thickness direction of the plate-shaped part being located on an inner side in a radial direction of the stator, and an engagement part which is protruded from the plate-shaped part to an outer side in a radial direction and is overlapped with an end face of the stator. The end plate is overlapped with the plate-shaped part on an opposite side to the stator so that the bearing member is held between the stator and the end plate.

In at least an embodiment of the present invention, an engagement part of the bearing member is engaged with an end face of the stator in a motor axial line direction and the end plate is overlapped with the plate-shaped part of the bearing member, which is located on an inner side of the stator, on an opposite side to the stator. Therefore, the bearing member is held by the stator and the end plate from both sides in the motor axial line direction through the engagement part and the plate-shaped part and is fixed between the stator and the end plate. In at least an embodiment of the present invention, an outer shape dimension of the plate-shaped part of the bearing member is smaller than an inner shape dimension of the stator and thus, before the end plate is fixed to the stator at the time of assembling the motor, the bearing member is capable of turning around the motor axial line with respect to the stator to adjust an angular position of the bearing member. Further, an angular position of the end plate can be changed with respect to the stator by turning the end plate around the motor axial line. Therefore, the bearing member is held between the stator and the end plate in a state that the bearing member and the end plate are disposed at an appropriate angular position.

In at least an embodiment of the present invention, the plate-shaped part is positioned by an inner peripheral face of the stator in the radial direction. According to this structure, the bearing member is disposed at an appropriate position in the radial direction with an inner peripheral face of the stator as a reference.

In at least an embodiment of the present invention, the engagement part is protruded to an outer side in the radial direction from an end face of the plate-shaped part on an opposite-to-output side to the stator. According to this structure, a dimension in the motor axial line direction of the motor can be shortened.

In at least an embodiment of the present invention, the engagement part is protruded to the opposite-to-output side with respect to an end face on the opposite-to-output side of the plate-shaped part, and the plate-shaped part and a portion of the engagement part which is protruded to the opposite-to-output side with respect to the end face on the opposite-to-output side of the plate-shaped part structure a thick wall portion.

In at least an embodiment of the present invention, a face on the opposite-to-output side of the thick wall part is a face on the most opposite-to-output side of the bearing member, and an end face on the opposite-to-output side of the plate-shaped part is located on an output side with respect to the face on the opposite-to-output side of the thick wall part.

In at least an embodiment of the present invention, a protruded part is formed on an end face of the plate-shaped part on the opposite-to-output side to the stator so as to protrude to an opposite side with respect to the end face of the plate-shaped part.

In at least an embodiment of the present invention, the engagement part is formed at plural positions, a plurality of the engagement parts is integrally connected with each other on a center side in a radial direction, and the plurality of the engagement parts is connected with the plate-shaped part to structure a thick wall portion.

In at least an embodiment of the present invention, a portion of the end plate which is overlapped with the engagement part in a motor axial line direction is formed to be an opening part. According to this structure, the end plate and the engagement part are not overlapped with each other in the motor axial line direction and thus a dimension in the motor axial line direction of the motor is shortened.

In the above-mentioned structure, it is preferable that the bearing member is prevented from turning in a circumferential direction by the engagement part which is fitted into the opening part. According to this structure, the bearing member is prevented from turning in a state that the end plate and the bearing member are combined with each other and thus another structure is not required to be added for preventing the turning.

In at least an embodiment of the present invention, the end plate is fixed to the stator on an outer side in a radial direction with respect to the plate-shaped part.

In at least an embodiment of the present invention, the end plate is fixed to the stator by welding.

In this case, it is preferable that a recessed part which is recessed to an inner side in the radial direction is formed on an outer circumferential edge of the plate-shaped part. According to this structure, the contacting area of the plate-shaped part with the end plate is reduced and thus, heat of welding is restrained from transmitting to the bearing member through the end plate when the end plate and the stator are fixed to each other by welding. Further, when the end plate and the stator are fixed to each other by welding, heat of welding can be restrained from transmitting to the bearing member through the stator. Therefore, heat deformation of the bearing member can be restrained.

In at least an embodiment of the present invention, the end plate is provided with a ring-shaped part which is formed with the opening part, and the ring-shaped part is overlapped with an end face on an opposite-to-output side of the plate-shaped part. In this case, it is preferable that the engagement part is protruded to the opposite-to-output side with respect to the end face on the opposite-to-output side of the plate-shaped part, the plate-shaped part and a portion of the engagement part which is protruded to the opposite-to-output side with respect to the end face on the opposite-to-output side of the plate-shaped part structure a thick wall portion, a face on the opposite-to-output side of the thick wall part is a face on the most opposite-to-output side of the bearing member, and an end face on the opposite-to-output side of the plate-shaped part is located at a position on an output side with respect to the face on the opposite-to-output side of the thick wall part.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an outward appearance of a motor in accordance with an embodiment of the present invention.

FIGS. 2(a) and 2(b) are explanatory views showing a structure of the motor shown in FIG. 1.

FIGS. 3(a) through 3(i) are explanatory views showing structural members used in the motor shown in FIG. 1.

FIGS. 4(a) and 4(b) are explanatory views showing a bearing member used in the motor shown in FIG. 1.

FIGS. 5(a) and 5(b) are explanatory views showing a bearing member which is used in a motor in accordance with another embodiment of the present invention.

### DETAILED DESCRIPTION OF THE PREFERRED EMBODIMENTS

A motor to which the present invention is applied will be described below with reference to the accompanying drawings. In the following descriptions, a side where a rotation shaft is protruded in a motor axial line direction is referred to as an “output side” and an opposite side to the side where the rotation shaft is protruded is referred to as an “opposite-to-output side”.

### [Entire Structure]

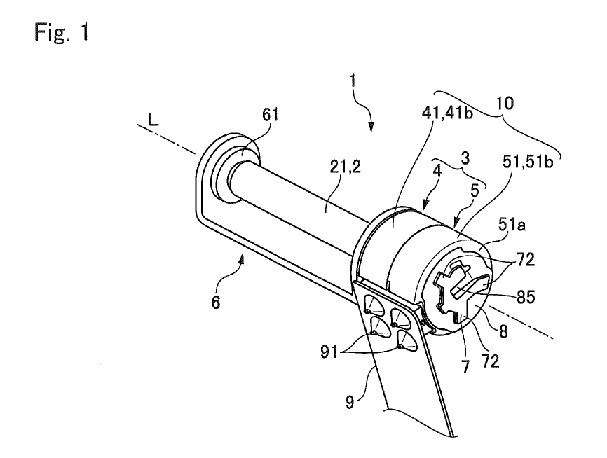

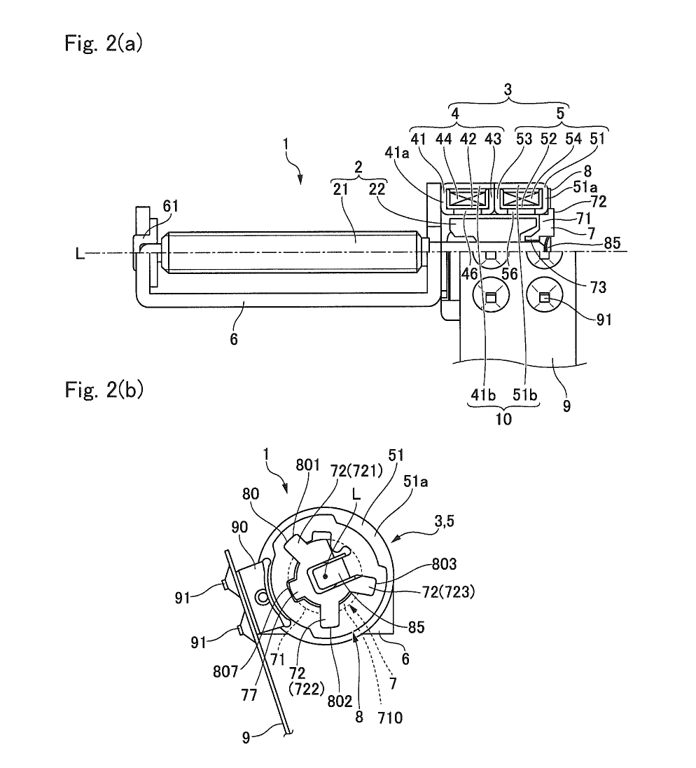

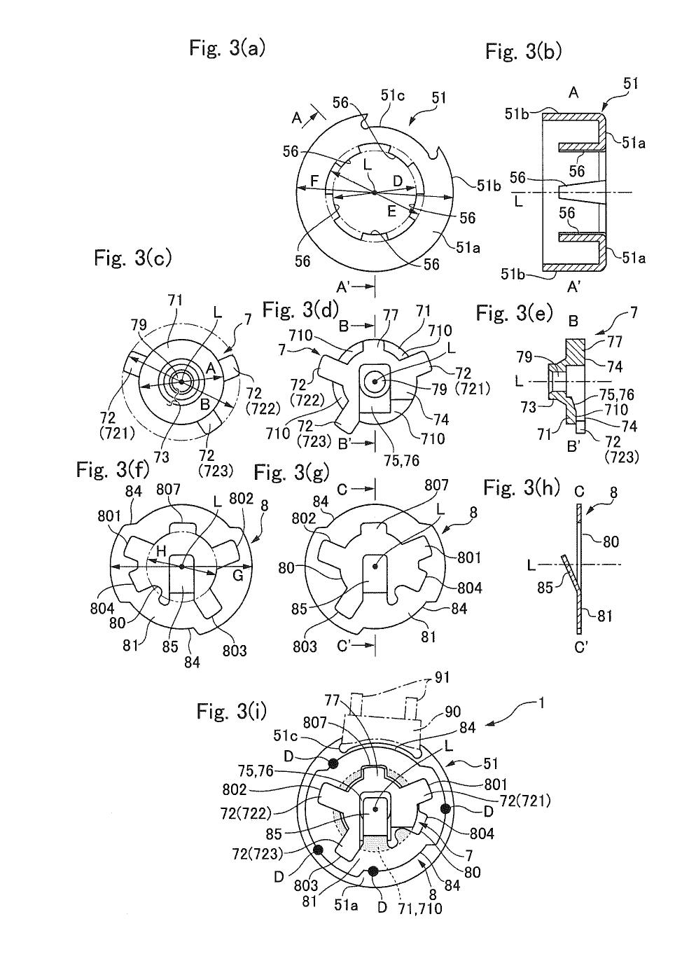

FIG. 1 is a perspective view showing an outward appearance of a motor in accordance with an embodiment of the present invention. FIGS. 2(a) and 2(b) are explanatory views showing a structure of the motor shown in FIG. 1. FIG. 2(a) is a half sectional view showing a motor which is partially cut and FIG. 2(b) is a side view showing the motor which is viewed from an opposite-to-output side. FIGS. 3(a) through 3(i) are explanatory views showing structural members used in the motor shown in FIG. 1. FIGS. 3(a) and 3(b) are explanatory views showing a second outer stator core, FIGS. 3(c) through 3(e) are explanatory views showing a bearing member, FIGS. 3(f) through 3(h) are explanatory views showing an end plate, and FIG. 3(i) is an explanatory view showing a state that the second outer stator core, the bearing member and the end plate are overlapped with each other. More specifically, FIG. 3(a) is a plan view showing a second outer stator core which is viewed from an opposite-to-output side and FIG. 3(b) is an “A-A” cross-sectional view. FIG. 3(c) is a bottom view showing a bearing member which is viewed from an output side, FIG. 3(d) is a front view showing the bearing member viewed from an opposite-to-output side, and FIG. 3(e) is its “B-B” cross-sectional view. FIG. 3(f) is a bottom view showing an end plate which is viewed from an output side, FIG. 3(g) is a front view showing the end plate viewed from an opposite-to-output side, and FIG. 3(h) is its “C-C” cross-sectional view.

As shown in FIG. 1 and FIGS. 2(a) and 2(b), a motor 1 in this embodiment is a PM type stepping motor which includes a rotor 2 in which a permanent magnet 22 in a cylindrical tube shape is fixed around a rotation shaft 21 and a tube-shaped stator 3 which is disposed so as to surround the rotor 2.

The stator 3 is structured so that a first stator assembly 4 in a cylindrical tube shape and a second stator assembly 5 in a cylindrical tube shape are superposed on each other in a motor axial line “L” direction and the first stator assembly 4 and the second stator assembly 5 are provided with a substantially similar structure. The first stator assembly 4 located on an output side includes a first outer stator core 41, a first bobbin 42 around which a coil 44 is wound, and a first inner stator core 43 which sandwiches the first bobbin 42 between the first outer stator core 41 and the first inner stator core 43. A plurality of pole teeth 46 which are formed in each of the first outer stator core 41 and the first inner stator core 43 is alternately juxtaposed each other in a circumferential direction along an inner peripheral face of the first bobbin 42. The second stator assembly 5 located on an opposite-to-output side includes a second outer stator core 51, a second bobbin 52 around which a coil 54 is wound, and a second inner stator core 53 which sandwiches the second bobbin 52 between the second outer stator core 51 and the second inner stator core 53. A plurality of pole teeth 56 which are formed in each of the second outer stator core 51 and the second inner stator core 53 is alternately juxtaposed each other in a circumferential direction along an inner peripheral face of the second bobbin 52.

In the stator 3 structured as described above, respective end faces on both sides in the motor axial line “L” direction are structured of the first outer stator core 41 and the second outer stator core 51. In this embodiment, the first outer stator core 41 is provided with a tube-shaped body part 41b which is extended from an outer circumferential edge of a circular ring-shaped end plate part 41a toward an opposite-to-output side in the motor axial line “L” direction. Further, the second outer stator core 51 is provided with a tube-shaped body part 51b which is extended from an outer circumferential edge of a circular ring-shaped end plate part 51a toward an output side in the motor axial line “L” direction (see FIGS. 3(a) and 3(b)). Therefore, in this embodiment, a motor case 10 is structured of the tube-shaped body part 41b of the first outer stator core 41 and the tube-shaped body part 51b of the second outer stator core 51.

A cut-out portion (not shown) is formed in the first outer stator core 41 and a cut-out portion 51c (see FIG. 3(a)) is formed in the tube-shaped body part 51b of the second outer stator core 51. In this embodiment, a terminal block 90 is protruded from the motor case 10 to an outer side in a radial direction through the cut-out portion 51c. The terminal block 90 is structured of a resin portion which is integrally formed of the first bobbin 42 and the second bobbin 52 and the like, and the terminal block 90 holds a plurality of terminal pins 91 around which end parts of the coils 44 and 54 are wound. A flexible circuit board 9 is connected with the terminal pins 91 by soldering or the like.

(Bearing Structure on Output Side)

A “U”-shaped plate 6 is fixed to the end plate part 41a of the first outer stator core 41 in the motor 1 and an end part on an output side of the rotation shaft 21 is rotatably supported by a bearing 61 which is held by a bent portion on a tip end side of the plate 6.

(Bearing Structure on Opposite-to-Output Side)

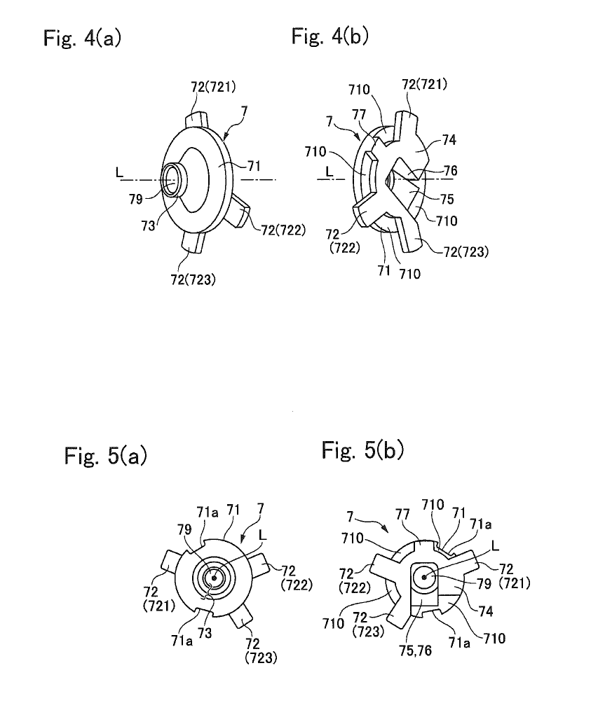

FIGS. 4(a) and 4(b) are explanatory views showing a bearing member used in the motor shown in FIG. 1. FIG. 4(a) is a perspective view showing the bearing member which is viewed from an output side and FIG. 4(b) is a perspective view showing the bearing member viewed from an opposite-to-output side.

As shown in FIGS. 2(a) and 2(b), an end part on the opposite-to-output side of the stator 3 is attached with a bearing member 7, which rotatably supports an end part on an opposite-to-output side of the rotation shaft 21, and an end plate 8 which holds the bearing member 7 between the stator 3 and the end plate 8.

(Structure of Bearing Member 7)

As shown in FIGS. 2(a) and 2(b), FIGS. 3(c), 3(d) and 3(e) and FIGS. 4(a) and 4(b), the bearing member 7 is a resin molded product which is provided with a plate-shaped part 71 and engagement parts 72 which are protruded to outer sides in the radial direction from an outer circumferential edge of the plate-shaped part 71. Further, a center of the plate-shaped part 71 is formed with a bearing 73 in a cylindrical tube shape which is fitted with the rotation shaft 21 to rotatably support the rotation shaft 21 in the radial direction. A shaft hole 79 on an inner side of the bearing 73 penetrates through the bearing member 7 in the motor axial line “L” direction and the shaft hole 79 is formed so as to have a step whose diameter is enlarged on an opposite-to-output side of the bearing member 7. In this embodiment, the bearing 73 is protruded toward a side of the rotor 2 from an end face on the output side of the plate-shaped part 71. However, an end face of the permanent magnet 22 used in the rotor 2 is recessed so as not to contact with the bearing 73 and thus rotation of the rotor 2 is performed without a problem.

In this embodiment, the plate-shaped part 71 is formed in a circular plate shape whose outer periphery is circular and the outer shape dimension “A” of the plate-shaped part 71 (diameter “A” of an outer circular periphery of the plate-shaped part 71, see FIG. 3(c)) is slightly smaller than an inner shape dimension “D” of the stator 3 (see FIG. 3(a)). Therefore, an outer peripheral face of the plate-shaped part 71 of the bearing member 7 can be turned around the motor axial line “L” with inner side faces of the pole teeth 56 of the second outer stator core 51 as a turning guide and thus an angular position of the bearing member 7 with respect to the stator 3 can be changed. In this case, it is sufficient that the plate-shaped part 71 of the bearing member 7 can be turned with the pole teeth 56 of the second outer stator core 51 as a turning guide and thus the plate-shaped part 71 is not required to be a complete circular shape. In this embodiment, the inner shape dimension “D” of the stator 3 is determined by a diameter of an imaginary circle which internally contacts with the inner side faces of the pole teeth 56 which are formed in the second outer stator core 51.

The engagement part 72 of the bearing member 7 is formed at three positions separated from each other in a circumferential direction and each of three engagement parts 72 (721, 722 and 723) is protruded so as to have side faces which are respectively extended to outer sides in the radial direction from an end face 710 on the opposite-to-output side of the plate-shaped part 71. In this embodiment, protruding dimensions in the radial direction of the three engagement parts 72 (721, 722 and 723) protruding from the plate-shaped part 71 to the outer side in the radial direction are equal to each other. Further, a diameter of an imaginary circle which circumscribes the outer side end parts of the engagement parts 72 in the radial direction (maximum outer shape dimension “B” in the radial direction of the bearing member 7, see FIG. 3(c)) is larger than an inner shape dimension “E” (see FIG. 3(a)) of the end plate part 51a of the second outer stator core 51 but is smaller than an outer shape dimension “F” (see FIG. 3(a)) of the end plate part 51a of the second outer stator core 51. Therefore, when the bearing member 7 is attached to the stator 3, the three engagement parts 72 (721, 722 and 723) are respectively abutted with the end plate part 51a of the second outer stator core 51. Further, the three engagement parts 72 are integrally connected with the plate-shaped part 71 on the center side in the radial direction and the three engagement parts 72 are connected with each other through the plate-shaped part 71 to form a thick wall portion 74.

A tapered face 75 is formed between the engagement part 721 and the engagement part 723 toward an inner side of the bearing 73 formed in a cylindrical tube shape from its outer peripheral side in an opposite-to-output side face of the bearing member 7. The tapered face 75 is reached to the shaft hole 79 and a groove 76 formed by the tapered face 75 is a region for disposing a spring part 85 described below and the groove 76 is formed for arranging the spring part 85.

A protruded part 77 similar to the engagement part 72 is formed on an opposite-to-output side face of the bearing member 7 at a position on an opposite side with respect to the groove 76 but the protruded part 77 does not protrude to an outer side in the radial direction from the plate-shaped part 71. The protruded part 77 is connected with the engagement parts 72 and thus the thick wall portion 74 is formed in a roughly ring shape. In this embodiment, the thickness dimensions (dimension in the motor axial line “L” direction) of all of the engagement parts 72 and the protruded part 77 are the same as each other and thus the opposite-to-output side face of the thick wall portion 74 forms a continuous flat face. Further, the thick wall portion 74 (engagement parts 72 and protruded part 77) is protruded to the opposite-to-output side with respect to the end face 710 on the opposite-to-output side of the plate-shaped part 71, and the opposite-to-output side face of the thick wall portion 74 is formed to be the most opposite-to-output side face of the bearing member 7. Therefore, the end face 710 on the opposite-to-output side of the plate-shaped part 71 is located at a position recessed to the output side with respect to the opposite-to-output side face of the engagement parts 72 and the protruded part 77, and the end face 710 on the opposite-to-output side of the plate-shaped part 71 is formed as a pressurized face by an end plate 8 described below.

(Structure of End Plate 8)

As shown in FIGS. 2(a) and 2(b) and FIGS. 3(f), 3(g) and 3(h), the end plate 8 is a metal member which is formed by press working to a metal plate and the end plate 8 is provided with a ring-shaped part 81 and an opening part 80 on its inner side. In this embodiment, the opening part 80 is formed over a region overlapping with the engagement parts 72, the protruded part 77 and the thick wall portion 74 of the bearing member 7. More specifically, regions of the end plate 8 overlapping with the engagement parts 721, 722 and 723 are respectively formed in opening parts 801, 802 and 803, and a region overlapping with the thick wall portion 74 is formed in an opening part 804 provided with a rectangular opening portion at a position interposed in a circumferential direction by the opening part 801 and the opening part 803. Further, a region of the end plate 8 overlapping with the protruded part 77 is formed in an opening part 807 and the opening parts 801, 802, 803, 804 and 807 are connected with each other to structure one large opening part 80. Therefore, when the end plate 8 is superposed on the opposite-to-output side face of the bearing member 7, the engagement parts 72, the thick wall portion 74 and the protruded part 77 are penetrated through the opening part 80 to the opposite-to-output side, and an inner circumferential edge of the ring-shaped part 81 of the end plate 8 is overlapped with the end face 710 on the opposite-to-output side of the plate-shaped part 71 of the bearing member 7 to restrict movement of the bearing member 7 to the opposite-to-output side. In this embodiment, the opening part 80 is provided with an opening shape which is substantially the same as the shape of the protruded part formed by combining all of the engagement parts 72, the thick wall portion 74 and the protruded part 77. In other words, widths in the circumferential direction of the opening parts 801, 802 and 803 are respectively set substantially the same as widths in the circumferential direction of the engagement parts 721, 722 and 723 and, when the end plate 8 is superposed on the opposite-to-output side face of the bearing member 7, the end plate 8 and the bearing member 7 are integrated with each other in the circumferential direction without rattling. Therefore, the engagement parts 72 (engagement part 721, 722 and 723) and the protruded part 77 are respectively fitted to the opening parts 801, 802, 803 and 807 to prevent turning of the bearing member 7 around the motor axial line “L”.

Further, a cut-out portion 84 is formed at an outer circumferential edge of the end plate 8 and, in this embodiment, the cut-out portion 84 is formed at two positions separated from each other in the circumferential direction. Therefore, the outer circumferential edge of the end plate 8 is located on an inner side in the radial direction in the cut-out portion 84. Therefore, even when the cut-out portion 51c is formed in the second outer stator core 51 for protruding the terminal block 90 to the outer side in the radial direction from the motor case 10, the outer circumferential edge of the end plate 8 is overlapped with the end plate part 51a of the second outer stator core 51 over the entire periphery. Further, the outer circumferential edge of the end plate 8 other than the cut-out portion 84 is formed in a large diameter and thus the end plate 8 and the end plate part 51a of the second outer stator core 51 are abutted with each other over a wide area.

In this embodiment, the end plate 8 is structured as an urging member (pressurization-applying member) which applies an urging force to the rotor 2 toward the output side. Therefore, a spring part 85 formed in a plate spring shape is cut and obliquely bent from an inner edge of the ring-shaped part 81 toward the center in the end plate 8. In this embodiment, the entire spring part 85 is obliquely extended toward the output side in a straight shape from the end plate 8.

An outer shape dimension “G” of the ring-shaped part 81 of the end plate 8 (see FIG. 3(f)) is set larger than an outer shape dimension “B” of the bearing member 7 (maximum outer shape dimension of the bearing member 7 which is formed by the tip ends of the engagement parts 72). Further, a diameter of a circle which internally contacts with the ring-shaped part 81 (inner shape dimension “H” of the ring-shaped part 81 (inner shape dimension for restricting the plate-shaped part 71 of the bearing member 7, see FIG. 3(f) is set smaller than an outer shape dimension “A” of the plate-shaped part 71 of the bearing member 7. Further, an outer shape dimension “G” of the ring-shaped part 81 of the end plate 8 (maximum outer shape dimension of the end plate 8) is smaller than an outer shape dimension “F” of the end plate part 51a of the second outer stator core 51. Therefore, in the steps described below, when the bearing member 7 is superposed on the second outer stator core 51, the end plate part 51a of the second outer stator core 51 is overlapped with the end plate 8 on an outer side in the radial direction of the bearing member 7. Accordingly, in this embodiment, when the end plate 8 is to be fixed to the stator 3 (fixed to the end plate part 51a of the second outer stator core 51), the end plate 8 and the end plate part 51a of the second stator core 51 are welded to each other at plural positions of the outer side edge of the end plate 8 as shown in FIG. 3(i) where the welded portion is shown by the black dot “D”. Specifically, the end plate 8 and the end plate part 51a of the second stator core 51 are welded to each other at positions of the maximum outer circumferential edge of the end plate 8 and positions of the outer circumferential edge of the cut-out portion 84. Therefore, in this embodiment, the end plate 8 is fixed to the stator 3 on an outer side in the radial direction with respect to the plate-shaped part 71 of the bearing member 7.

(Assembling Method for Motor 1 and Fixing Method of Bearing Member 7 and the Like)

In order to assemble the motor 1 by using the members described with reference to FIGS. 3(a) through 3(i), in this embodiment, first, as shown in FIG. 3(i), the bearing member 7 and the end plate 8 are superposed on each other. As a result, the engagement parts 72 and the protruded part 77 of the bearing member 7 are fitted into the opening part 80 of the end plate 8 and are protruded to the opposite-to-output side with respect to the end plate 8. Further, the ring-shaped part 81 of the end plate 8 is overlapped with the end face 710 on the opposite-to-output side of the plate-shaped part 71 of the bearing member 7 and the bearing member 7 and the end plate 8 are integrated with each other.

Next, after the rotation shaft 21 is inserted into the shaft hole 79 of the bearing member 7, as shown in FIGS. 2(a) and 2(b) and FIG. 3(i), the bearing member 7 and the end plate 8 are superposed on the end plate part 51a of the second outer stator core 51 from the opposite-to-output side. As a result, the plate-shaped part 71 of the bearing member 7 is located so as to substantially abut with the inner side of the second outer stator core 51 (substantially abut with the inner faces of the pole teeth 56) and the engagement parts 72 of the bearing member 7 are overlapped with the end plate part 51a on the opposite-to-output side and are abutted with the end plate part 51a. In this state, the plate-shaped part 71 of the bearing member 7 is positioned by the pole teeth 56 of the second outer stator core 51 (inner peripheral face of the stator 3) in the radial direction. In this case, when the bearing member 7 and the end plate 8 are turned in the circumferential direction depending on application or the like of the motor 1 so that the plate-shaped part 71 of the bearing member 7 is guided by the inner peripheral faces of the pole teeth 56 of the second outer stator core 51, an angular position of the bearing member 7 and the end plate 8 is adjusted with respect to the second outer stator core 51 (stator 3).

Next, as shown in FIG. 3(i), the outer circumferential edge of the end plate 8 and the end plate part 51a of the second outer stator core 51 are welded to each other and the outer circumferential edge of the end plate 8 and the second outer stator core 51 are fixed to each other.

Further, in order to assemble the motor 1, another method may be adopted in which the first outer stator core 41 is assembled to the frame 6 to manufacture a first assembly and the bearing member 7 and the end plate 8 are assembled to the second outer stator core 51 to manufacture a second assembly. In this case, when the second assembly is to be manufactured, the bearing member 7 and the end plate 8 are turned in the circumferential direction depending on application or the like of the motor 1 to adjust an angular position of the bearing member 7 and the end plate 8 with respect to the second outer stator core 51 (stator 3) and then, the outer circumferential edge of the end plate 8 and the end plate part 51a of the second outer stator core 51 are welded to each other and the outer circumferential edge of the end plate 8 and the second outer stator core 51 are fixed to each other. Next, the bobbin 42 around which the coil 44 is wound and the inner stator core 43 are fitted into the first assembly to manufacture the first stator assembly 4 and the bobbin 52 around which the coil 54 is wound and the inner stator core 53 are fitted into the second assembly to manufacture the second stator assembly 5. Next, the rotor 2 is fitted into the first stator assembly 4 and then the second stator assembly 5 is fitted around the rotor 2 and, after that, the first stator assembly 4 and the second stator assembly 5 are connected with each other by welding.

In a case that either of the above-mentioned assembling methods is adopted, the engagement parts 72 of the bearing member 7 are abutted and engaged with the end plate part 51a of the second outer stator core 51 at the end part on the opposite-to-output side in the motor axial line “L” direction of the stator 3, and a gray region shown in FIG. 3(i) of the plate-shaped part 71 of the bearing member 7 is abutted and engaged with the ring-shaped part 81 of the end plate 8 on the output side and thus the bearing member 7 is sandwiched between the stator 3 and the end plate 8. Therefore, movement of the bearing member 7 to the opposite-to-output side in the motor axial line “L” direction is restricted by the end plate 8 through the plate-shaped part 71 and movement of the bearing member 7 to the output side in the motor axial line “L” direction is restricted by the second outer stator core 51 through the engagement parts 72. Further, the engagement parts 72 (engagement part 721, 722 and 723) and the protruded part 77 are respectively fitted into the opening parts 801, 802, 803 and 807 to restrict turning of the bearing member 7 around the motor axial line “L”. Therefore, when the motor 1 is to be assembled, the bearing member 7 is fixed with a simple step in which the bearing member 7 is sandwiched between the second outer stator core 51 and the end plate 8 and the end plate 8 is welded to the second outer stator core 51.

Further, when the bearing member 7 is fixed to the end part of the stator 3 by the end plate 8, the spring part 85 of the end plate 8 is abutted with a shaft end of the rotation shaft 21 of the rotor 2 to urge the rotation shaft 21 to the output side in the motor axial line “L” direction. Therefore, the bearing member 7 is fixed by the end plate 8 and a shake in the motor axial line “L” direction of the rotor 2 is restrained. Further, the spring part 85 urges the shaft end of the rotation shaft 21 at an eccentric position with respect to the shaft end of the rotation shaft 21. Therefore, the rotation shaft 21 is pressed against a specified portion in the circumferential direction of the inner peripheral face of the bearing 73 by a side pressure applied by the spring part 85. Accordingly, movement of the rotation shaft 21 in the radial direction to be abutted with the inner peripheral face of the bearing 73 is hard to occur. As a result, occurrence of abnormal noise due to abutting of the rotation shaft 21 with the inner peripheral face of the bearing 73 is restrained. In this embodiment, the bearing member 7 and the end plate 8 can be turned in the circumferential direction with the plate-shaped part 71 of the bearing member 7 as a turning guide with respect to the inner peripheral faces of the pole teeth 56 of the second outer stator core 51 and thus, the angular position of the bearing member 7 and the end plate 8 with respect to the stator 3 can be adjusted. Therefore, after the urging position of the spring part 85 with respect to the shaft end of the rotation shaft 21 is set at an appropriate position, the end plate 8 is welded and fixed to the second outer stator core 51.

(Principal Effects in this Embodiment)

As described above, in this embodiment, when the motor 1 is to be assembled, the bearing member 7 is held between the stator 3 and the end plate 8 by welding the end plate 8 to the second outer stator core 51 in a state that the bearing member 7 is sandwiched between the second outer stator core 51 and the end plate 8. In this embodiment, the outer shape dimension “A” of the plate-shaped part 71 of the bearing member 7 is smaller than the inner shape dimension “D” of the stator 3 and thus, before the end plate 8 is to be fixed to the stator 3 at the time of assembling the motor 1, the bearing member 7 is capable of being turned around the motor axial line “L” together with the end plate 8 with respect to the stator 3 and, when the turning is performed, the angular position of the bearing member 7 can be changed. Further, the angular position of the end plate 8 can be changed with respect to the stator 3 by turning the end plate 8 having the spring part 85 around the motor axial line “L”. Accordingly, the bearing member 7 is held between the stator 3 and the end plate 8 in a state that the bearing member 7 and the spring part 85 of the end plate 8 are disposed at an appropriate angular position. Therefore, when the rotor 2 is rotated in a state that a load is applied to the rotor 2, occurrence of an abnormal noise is restrained.

For example, when the rotation shaft 21 is rotated in a state that a load is applied to the rotation shaft 21 from a side, an abnormal noise may occur at a contacted portion of the bearing member 7 with the rotation shaft 21 depending on an angular position of the bearing member 7 due to the positional accuracy of the bearing 73. However, in this case, occurrence of the abnormal noise is prevented by appropriately setting the angular position of the bearing member 7 in accordance with the situations where the motor 1 is used, for example, a direction of a load applied to the rotation shaft 21. Further, in a case that pressurization is applied to the rotor 2 by the spring part 85 which is cut and obliquely bent in the end plate 8 like the embodiment described above, an abnormal noise may occur when the rotor 2 is rotated depending on a relationship between a direction of a load applied to the rotation shaft 21 from a side and a position of the spring part 85 (direction of a side pressure of the spring part 85 applied to the rotation shaft 21). However, in this case, occurrence of the abnormal noise is prevented by appropriately setting the angular position of the bearing member 7 and the end plate 8 to optimize the relationship between a direction of a load applied to the rotation shaft 21 from a side and the position of the spring part 85.

Further, in this embodiment, the ring-shaped part 81 of the end plate 8 supports the plate-shaped part 71 over its roughly entire periphery except the positions of the engagement parts 72 and thus, even when the size of the motor 1 is reduced, the bearing member 7 is supported by the end plate 8. Further, the ring-shaped part 81 of the end plate 8 supports the plate-shaped part 71 in a wide region over its roughly entire periphery except the positions of the engagement parts 72. Therefore, even when an excessive force is applied and a force is acted on the bearing member 7 so as to press the bearing member 7 toward the opposite-to-output side, the ring-shaped part 81 of the end plate 8 is provided with a sufficient strength for preventing the bearing member 7 from detaching to the opposite-to-output side.

Further, in this embodiment, the plate-shaped part 71 is positioned in the radial direction by the inner peripheral face of the stator 3 and thus the bearing member 7 can be disposed at an appropriate position in the radial direction with the inner peripheral face of the stator 3 as a reference. In other words, the plate-shaped part 71 is positioned in the radial direction by the inner peripheral faces of the pole teeth 56 of the stator 3 and thus centering of the bearing 73 of bearing member 7 is performed with a high degree of accuracy with the inner peripheral faces of the pole teeth 56 as a reference.

Further, the engagement parts 72 (engagement parts 721, 722 and 723) and the protruded part 77 are respectively fitted into the opening parts 801, 802, 803 and 807 to prevent turning of the bearing member 7 around the motor axial line “L” and thus another structure is not required to be added for preventing the turning.

Further, in this embodiment, the engagement parts 72 are protruded from the end face 710 of the plate-shaped part 71 on the opposite side to the stator 3 to the outer side in the radial direction. Therefore, the dimension in the motor axial line “L” direction of the motor 1 can be shortened. In addition, the end plate 8 is formed with the opening part 80 in a portion overlapping with the engagement parts 72 and the like in the motor axial line “L” direction. Accordingly, the end plate 8 and the engagement parts 72 are not overlapped with each other in the motor axial line “L” direction and thus a dimension in the motor axial line “L” direction of the motor 1 can be shortened.

Further, the end plate 8 is fixed to the stator 3 by welding on an outer side in the radial direction with respect to the plate-shaped part 71. In addition, the end plate 8 is welded on further outer sides in the radial direction with respect to the engagement parts 72 and the welded portions are sufficiently separated from the bearing member 7. Therefore, the bearing member 7 is hard to be deformed by heat of welding. Especially, in this embodiment, the bearing 73 of the bearing member 7 is largely separated from the welded portions and thus the bearing member 7 is hard to be deformed by heat of welding. Therefore, the bearing 73 is capable of stably supporting the rotation shaft 21.

### [Other Embodiments]

FIGS. 5(a) and 5(b) are explanatory views showing a bearing member 7 which is used in a motor 1 in accordance with another embodiment of the present invention. FIG. 5(a) is a bottom view showing the bearing member 7 which is viewed from an output side and FIG. 5(b) is a front view showing the bearing member 7 viewed from an opposite-to-output side.

In the motor 1 which is described with reference to FIG. 1 through FIG. 4(b), the plate-shaped part 71 of the bearing member 7 is formed in a circular shape. However, as shown in FIGS. 5(a) and 5(b), a recessed part 71a which is recessed to an inner side in the radial direction may be formed on an outer circumferential edge of the plate-shaped part 71. According to this structure, when the motor 1 is structured as described with reference to FIG. 1 through FIG. 4(b), the contacting area of the plate-shaped part 71 with the end plate 8 is reduced and thus, heat of welding is restrained from transmitting to the bearing member 7 through the end plate 8 when the end plate 8 and the second stator core 51 are fixed to each other by welding. Further, when the end plate 8 and the second stator core 51 are fixed to each other by welding, heat of welding can be restrained from transmitting to the bearing member 7 through the second stator core 51. Therefore, heat deformation of the bearing member 7, especially heat deformation of the bearing 73 can be restrained.

In the embodiment described above, as an example, the present invention is applied to the motor 1 in which the stator 3 and the end plate 8 are fixed to each other by welding. However, the present invention may be applied to a motor 1 in which the stator 3 and the end plate 8 are fixed to each other by a method such as caulking.

In the embodiment described above, as an example, the present invention is applied to a stepping motor but the present invention may be applied to a motor other than a stepping motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor comprising a rotation shaft;
a stator which is formed in a tube shape and disposed around the rotor;
a bearing member which rotatably supports the rotor at one end part in a motor axial line direction of the stator; and
an end plate which is provided with a spring part, the spring part urging the rotation shaft in the motor axial line direction and holding the bearing member between the stator and the end plate;
wherein the bearing member comprises:
a plate-shaped part whose outer shape dimension is smaller than an inner shape dimension of the stator, at least a part in a thickness direction of the plate-shaped part being located on an inner side in a radial direction of the stator; and
an engagement part which is protruded from the plate-shaped part to an outer side in a radial direction and is overlapped with an end face of the stator; and
wherein the end plate is overlapped with the plate-shaped part on an opposite side to the stator so that the bearing member is held between the stator and the end plate.

2. The motor according to claim 1, wherein the plate-shaped part is positioned by an inner peripheral face of the stator in the radial direction.

3. The motor according to claim 1, wherein the engagement part is protruded to an outer side in the radial direction from an end face of the plate-shaped part on an opposite-to-output side to the stator.

4. The motor according to claim 3, wherein
the engagement part is protruded to the opposite-to-output side with respect to an end face on the opposite-to-output side of the plate-shaped part, and
the plate-shaped part and a portion of the engagement part which is protruded to the opposite-to-output side with respect to the end face on the opposite-to-output side of the plate-shaped part structure a thick wall portion.

5. The motor according to claim 4, wherein
a face on the opposite-to-output side of the thick wall part is a face on the most opposite-to-output side of the bearing member, and
an end face on the opposite-to-output side of the plate-shaped part is located on an output side with respect to the face on the opposite-to-output side of the thick wall part.

6. The motor according to claim 1, wherein a protruded part is formed on an end face of the plate-shaped part on the opposite-to-output side to the stator so as to protrude to an opposite side with respect to the end face of the plate-shaped part.

7. The motor according to claim 1, wherein
the engagement part is formed at plural positions,
a plurality of the engagement parts is integrally connected with each other on a center side in a radial direction, and
the plurality of the engagement parts is connected with the plate-shaped part to structure a thick wall portion.

8. The motor according to claim 1, wherein a portion of the end plate which is overlapped with the engagement part in a motor axial line direction is formed to be an opening part.

9. The motor according to claim 8, wherein the bearing member is prevented from turning in a circumferential direction by the engagement part which is fitted into the opening part.

10. The motor according to claim 1, wherein the end plate is fixed to the stator on an outer side in a radial direction with respect to the plate-shaped part.

11. The motor according to claim 10, wherein the end plate is fixed to the stator by welding.

12. The motor according to claim 11, wherein a recessed part which is recessed to an inner side in the radial direction is formed on an outer circumferential edge of the plate-shaped part.

13. The motor according to claim 8, wherein
the end plate is provided with a ring-shaped part which is formed with the opening part, and
the ring-shaped part is overlapped with an end face on an opposite-to-output side of the plate-shaped part.

14. The motor according to claim 13, wherein
the engagement part is protruded to the opposite-to-output side with respect to the end face on the opposite-to-output side of the plate-shaped part,
the plate-shaped part and a portion of the engagement part which is protruded to the opposite-to-output side with respect to the end face on the opposite-to-output side of the plate-shaped part structure a thick wall portion,
a face on the opposite-to-output side of the thick wall part is a face on the most opposite-to-output side of the bearing member, and
an end face on the opposite-to-output side of the plate-shaped part is located at a position on an output side with respect to the face on the opposite-to-output side of the thick wall part.
